(19) United States
(12) Patent Application Publication
(10) Pub. No.: US 2006/0019019 A1
(43) Pub. Date: Jan. 26, 2006

(54) Lemon beverage

(76) Inventors: Thomas W. Rohaly, Weehawken, NJ (US); Adam Williams, Weehawken, NJ (US); Lara A. Holzman, New York, NY (US); Laurence I. Holzman, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/186,652

(22) Filed: Jul. 21, 2005

Related U.S. Application Data
(60) Provisional application No. 60/590,604, filed on Jul. 23, 2004.

(51) Int. Cl. A23L 2/00

(52) U.S. Cl. 426/590

(57) ABSTRACT

A beverage is provided that includes lemon flavoring, a sweetener, water, and vanilla flavoring.

### FIELD OF THE INVENTION

The present invention relates to the field of beverages, and non-carbonated beverages in particular.

### BACKGROUND OF THE INVENTION

Lemonade is a popular beverage which has been commercially available for at least a hundred years. Typically, lemonade is prepared with lemon flavoring, a sweetener, and water. For example, product literature for Newman's Own®. Lemonade indicates that its ingredients consist of Pure Filtered Water, High Fructose Corn Syrup, Sugar, Lemon Juice from Concentrate, Lemon Pulp and Lemon Oil.

Lemonade may also include other ingredients such as colorings, preservatives, salts, etc. For example, product literature for Snapple® Lemonade indicates that its ingredients consist of Water, High Fructose Corn Syrup, Citric Acid, Lemon Juice From Concentrate, Gum Acacia, Natural Lemon Flavor With Other Natural Flavors, Salt, Ascorbic Acid (Vitamin C), Beta Carotene (For Color).

### SUMMARY OF THE INVENTION

In accordance with a first embodiment of the present invention, a lemon drink is provided which includes lemon flavoring, a sweetener, vanilla, and water. Preferably, the drink includes a base concentrate containing from about 15% to about 25% lemon juice, from about 1% to about 30% sweetener, from about 0.2% to about 0.8% vanilla, and from about 45% to about 84% water. The drink preferably includes from about 1.5 to 5 parts of the base concentrate to 5 parts water, more preferably from about 2 to about 5 parts of base concentrate, to 5 parts water, and more preferably from about 3 to about 5 parts of base concentrate to 5 parts water. Most preferably, the concentrate includes from about 20% to about 22% lemon juice, from about 20% to about 22% sugar, about 0.4% vanilla, and from about 56% to about 60% water, and the drink includes 3 parts concentrate to 5 parts water. In any event, it should be understood that additional ingredients, such as preservatves, colorants, vitamins, salts, and the like can be added.

Expressed in terms of cups and tablespoons of the above ingredients, for every 3 cups of lemon juice, the concentrate most preferably includes about 3 cups of cane sugar, about 8 cups of water, and about one tablespoon of vanilla.

Although the drink is most conveniently made from a base concentrate, it should be understood that the preparation of the concentrate could be omitted, i.e., by initially mixing the lemon juice, sweetener, and vanilla with the full quantity of desired water. In accordance with such an embodiment, the beverage contains from about 3.5% to about 25% sugar, from about 3.5% to about 25% lemon juice, from about 0.04% to about 0.80% vanilla, and from about 56% to about 90% water. For example, the drink could contain, for every 3 cups of lemon juice: 3 cups of cane sugar, 1/16 cup (one tablespoon) of vanilla, and from about 8 to about 55 cups of water.

The vanilla provides a unique flavor to the lemonade drink, which is not achieved with prior art compositions.

Preferably, the lemon juice is pure lemon juice removed from lemons. However, in other embodiments, other lemon flavorings known in the art may be used, including artificial flavorings. The amount of such other lemon flavorings should be an amount that provides an equivalent lemon taste to the amount of lemon juice described above.

Preferably, the vanilla is derived from vanilla beans, and comprises vanilla extract. However, in other embodiments, other types of vanilla flavoring may be substituted for the vanilla extract, including artificial vanilla flavorings.

The sweetener is preferably sugar and most preferably cane sugar. However, other known sweeteners may be used, including but not limited to, sucrose, e.g. from cane or beet dextrose, fructose, lactose, maltose, glucose syrup solids, corn syrup solids, invert sugar, hydrolyzed lactose, honey, maple sugar, cane sugar, brown sugar, molasses and the like; aspartame, cyclamates, saccharin, acesulfame-K, neohesperidin dihydrochalcone, sucralose, alitame, stevia sweeteners, glycyrrhizin, thaumatin and the like and mixtures thereof; as well as sugar alcohols such as sorbitol, mannitol, xylitol, maltitol, isomalt, lactitol and the like. The amount of sweetener used in the embodiments of the present invention are preferably of an equivalent sweetness to the amounts of cane sugar described above. One of ordinary skill in the art will readily appreciate how to convert from one sweetener to another. As an example, one cup of cane sugar is equivalent to 8 teaspoons of Sweet & Low brand saccharine.

In accordance with another embodiment of the present invention, in addition to water, sweetener, lemon and vanilla flavorings (natural or artificial), the beverage includes one or more other substances such as fruit flavorings (such as strawberry, raspberry, lime, orange, kiwi, watermelon, apple, peach), corn starch, glycerol ester of wood rosin, sodium hexametaphosphate, sodium benzoate, potassium sorbate, EDTA, mint flavoring, ginger flavoring, nutmeg flavoring, honey flavoring, clove flavoring, cinnamon flavoring, lemon zest or rind. The beverage may also include colorants and preservatives. Preferably, however, the beverage is all natural and preservative free.

### EXAMPLE 1

A base concentrate is prepared as follows:

| | |
|---|---|
| 3 cups lemon juice | 21.333% |
| 3 cups cane sugar | 21.333% |
| 8 cups water | 56.888% |
| 1 Tablespoon vanilla | 0.444% |

The base concentrate is then mixed as follows: 3 parts concentrate to 5 parts water.

What is claimed is:

1. A beverage comprising lemon flavoring, a sweetener, water, and vanilla flavoring.

2. The beverage of claim 1, wherein the lemon flavoring is lemon juice.

3. The beverage of claim 1, wherein the vanilla flavoring is vanilla.

4. The beverage of claim 1, wherein the beverage is non-carbonated.

5. The beverage of claim 1, wherein the sweetener is cane sugar.

6. The beverage of claim 3, wherein the vanilla is vanilla extract.

7. The beverage of claim 1, wherein the vanilla flavoring is artificial vanilla flavoring.

8. The beverage of claim 1, wherein the lemon flavoring is lemon juice, the vanilla flavoring is vanilla, and the sweetener is can sugar, and, for ever 3 cups of lemon juice, the beverage contains about 3 cups of cane sugar, about one tablespoon of vanilla, and from about 8 to about 55 cups of water.

9. The beverage of claim 1, wherein the sweetener is sugar, and wherein for every 3 cups of lemon flavoring, the beverage contains from about 3 cups of sugar, about one tablespoon of vanilla flavoring, and from about 8 to about 55 cups of water.

10. The beverage concentrate, comprising: from about 15% to about 25% lemon juice, from about 1% to about 30% of a sweetener from about 0.2% to about 0.8% vanilla, and from about 45% to about 84% water.

11. A beverage, comprising from about 3.5% to about 25% sugar, from about 3.5% to about 25% lemon juice, from about 0.04% to about 0.80% vanilla, and from about 56% to about 90% water.

12. A beverage consisting essentially of lemon flavoring, a sweetener, water, and vanilla flavoring.

13. The beverage of claim 12, wherein the beverage is non-carbonated.

14. The beverage of claim 12, wherein the sweetener is cane sugar.

15. The beverage of claim 12, wherein the vanilla flavoring is vanilla extract.

16. The beverage of claim 12, wherein the vanilla flavoring is artificial vanilla flavoring.

17. The beverage of claim 12, wherein the lemon flavoring is lemon juice.

18. The beverage of claim 12, wherein the lemon flavoring is lemon juice, the vanilla flavoring is vanilla, and the sweetener is cane sugar, and, for every 3 cups of lemon juice, the beverage contains about 3 cups of cane sugar, about one tablespoon of vanilla, and from about 8 to about 55 cups of water.

19. The beverage of claim 12, wherein the sweetener is an artificial sweetener.

20. A beverage concentrate, consisting essentially of: from about 15% to about 25% lemon juice, from about 1% to about 30% of a sweetener, from about 0.2% to about 0.8% vanilla, and from about 45% to about 84% water.

21. A beverage, consisting essentially of from about 3.5% to about 25% sugar, from about 3.5% to about 25% lemon juice, from about 0.4% to about 0.80% vanilla, and from about 56% to about 90% water.
